(19) United States
(12) Patent Application Publication
(10) Pub. No.: US 2010/0287201 A1
(43) Pub. Date: Nov. 11, 2010

(54) METHOD AND A SYSTEM FOR IDENTIFYING ELEMENTARY CONTENT PORTIONS FROM AN EDITED CONTENT

(75) Inventors: Marijn Christian Damstra, Amsterdam (NL); Mehmet Utku Celik, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/811,168

(22) PCT Filed: Dec. 15, 2008
(86) PCT No.: PCT/IB2008/055299

§ 371 Date: Jun. 29, 2010

(30) Foreign Application Priority Data
Jan. 4, 2008 (EP) 08150048.0

(51) Int. Cl. G06F 17/30

(52) U.S. Cl. 707/780; 707/E17.014; 707/769

(57) ABSTRACT

This invention relates to a method and a system for identifying elementary content portions from an edited content. A log is generated indicating the elementary content portions used in the edited content. Fingerprints are obtained from the elementary content portions as indicated in the log. Characteristic information is determined about the elementary content portions by comparing the fingerprints to fingerprints of registered content having associated characteristic information.

### FIELD OF THE INVENTION

The present invention relates to a method for identifying elementary content portions from an edited content. The present invention further relates to a server adapted to be coupled to at least one client for identifying elementary content portions from an edited content generated by the client, and to a client for editing content adapted to be coupled to said server. The present invention also relates to a system for identifying elementary content portions from an edited content.

### BACKGROUND OF THE INVENTION

Photo, video and other content sharing sites such as Flickr, Google Video and Youtube have become very popular among the public for consuming and distributing video content. This content is uploaded by the public and largely originates from two sources: individual users that record e.g. their holiday video and commercially produced videos, e.g. an episode of a TV series or a Hollywood movie. The latter is a concern for the content industry, as their investments in producing content offer less return. Therefore, the content industry requires sharing sites to remove videos or other materials of which they are copyright holders, or share (advertising) revenue with them.

In order to distinguish the upload of an individual's own material from the upload of someone else's work without permission, fingerprinting technology is used. Fingerprints of commercial content are used to detect uploads of this content and trigger appropriate action (e.g. block upload, compensate copyright holder etc.). Many technologies for identifying content using content fingerprints or hashes exist. For audio, see the overview in P. Cano et al, ‘A Review of Audio Fingerprinting’, The Journal of VLSI Signal Processing 41(3), p. 271-283. For video, see J. Oostveen, T. Kalker and J. Haitsma, ‘Feature Extraction and a Database Strategy for Video Fingerprinting’, in Lecture Notes in Computer Science volume 2314/2002, Springer Berlin, pages 67-81. Also see international patent application WO 2002/065782-A1.

Recently, a new trend has emerged: co-creation. Co-creation refers to generating a derivative work using works from other parties, such as mixing, mash-ups, reformatting, forming collages, etc. The editing of content however deteriorates the performance of fingerprinting techniques. For instance, if a commercial content is modified and placed in a complex collage, the fingerprinting algorithms may fail to identify this commercial content from the collage because of the surrounding other content. Searching for all possible parts in a collage may be too complex, thus requiring significant computational resources for the fingerprinting system.

Another difficulty in identifying content from a derivative work involves the length of the commercial content segment used in the derivative work. In general, shorter content segments are harder to identify, as they are less distinctive than longer content segments. This difficulty may reveal itself in two ways: If the fingerprint algorithm is lenient, it may lead up to more segments identified falsely. On the other hand, if the algorithm is strict, it may lead up to more unidentified segments. Searching for all possible parts will further exacerbate the problem as the total number of false identifications will be proportional to the number of identification trials as well as the false identification rate.

### BRIEF DESCRIPTION OF THE INVENTION

The object of the present invention is to improve upon the above by avoiding the need to obtain fingerprints from substantially the entire length of a content item.

According to one aspect the present invention relates to a method for identifying elementary content portions from an edited content containing one or more elementary content portions, the method comprising:

receiving said edited content and a log indicating one or more elementary content portions used in the edited content,

obtaining fingerprints from the one or more elementary content portions as indicated in the log, and

determining characteristic information about said elementary content portions by comparing said fingerprints to fingerprints of registered content having associated characteristic information.

The log facilitates the identification of elementary content portions that are re-used in the edited content as it indicates these portions. Information in the log is used to efficiently compute fingerprints and identify these portions without the need for computing fingerprints over the entire length of the edited content. Essentially, only the correctness of the log is verified. A portion not listed in the log is not fingerprinted. The characteristic information determined by the method may simply be the identity of elementary content portions, for instance the name of the movie. Alternatively, it may be usage information related to the elementary content portion, for instance that it cannot be used without prior written permission.

The log may further state what these elementary content portions are and how they are used. Consequently, the identification process is further simplified as explained in the embodiments below. Furthermore, presence of correct information in the log may be used to rate the trustworthiness of the author of the edited content. If an author consistently supplies correct logs, then the algorithm may rate the author as “honest” and provide benefits to award this behavior. For instance, it may accept logs and edited content from trusted authors without checking them. This saves processing power as less checking is required for honest users. System-wide incentives may also be provided, e.g. giving a discount, credits, or benefits or publishing the content with priority. If, however, the information presented in the log is incorrect, the algorithm may rate the author as “dishonest” and thoroughly check all his submissions with stricter criteria.

In one embodiment, said characteristic information is used to obtain rights associated with the elementary content portions and thus to determine rights associated with the edited content. Accordingly, if the usage rules for each elementary content portion states that each part is available as Creative Commons Attribution Only (http://creativecommons.org), the edited content may also be considered as Creative Commons Attribution Only. Thus, a method is provided to associate the rights bound to the elementary content portions to the edited content.

In one embodiment, said characteristic information is used to derive a compensation scheme associated with the edited content. Thus, a compensation scheme model is provided. As an example, it is determined that the audio track will cost 1 Euro and that a part of the movie costs 50 cents. Thus, the edited content can be available for at least 1.50 Euros. The compensation scheme may further state how to pay the audio and movie owner etc.

In one embodiment, the log further contains at least some characteristic information about at least one of the elementary content portions used in the edited content. Accordingly, the author supplies further information about the elementary content portions in the log, such as meta-data related to the elementary content portion. As an example, if the elementary content portion is an excerpt from a commercial movie, the log may contain the name of that movie. Similarly, if a content portion is generated by the author, then it may include an identifier saying e.g. “my vacation photo taken at Nov. 11, 2007 in Paris” plus addition information such as “user generated content” indicating that the content comes from the author.

In one embodiment, said step of comparing said fingerprints is limited to fingerprints of the registered contents having characteristic information matching those as indicated in the log. Accordingly, the identification process is further simplified. Instead of comparing the fingerprint of the elementary content portion to all fingerprints from a catalogue of registered movies, the comparison is limited to a smaller subset of fingerprints from only the movies with matching characteristic information. For instance, if the log specifies the characteristic information about an elementary content portion as “Pirates of the Caribbean”, then the fingerprint comparison (searching or matching process) is limited to the fingerprints of only those movies having the same name.

In one embodiment, the characteristic information includes a usage license of the elementary content portions, the method further including the step of verifying the validity of the usage license. Accordingly, it is possible to check whether the author of the edited content has followed the usage license and whether the author has the right to use these portions. For instance, the author may buy a usage license for a particular piece of content from its owner and include this license in the log. Upon verification of this license, possibly by verifying the attached digital signature, a decision is reached about the re-distribution status of the edited content. Also, the author of the edited content may be rated based on whether he/she follows the usage license or not.

In one embodiment, the method further comprises verifying the validity of the characteristic information contained in the log by checking if said information matches with the characteristic information of the corresponding registered content. Therefore, it is possible to detect whether the author is honest or not based on whether he is telling the truth or not. As an example, the author indicates that only elementary content portion “A” is comprised in the edited content. By doing such a validity check it is possible to see whether the author is telling the truth or not. Thus, a good indicator is provided indicating whether the author is honest or not.

In one embodiment, a reputation measure of the author of the edited content and the log is determined based on said validity of the characteristic information of said elementary content portions. Thus, it is possible to grade the author of the edited content in mathematical terms. As an example, by giving the author a grade in the interval from 0-10, where “0” means that the author can not be trusted, and 10 means that the author can be fully honest author.

In one embodiment, the step of comparing the fingerprints obtained from the elementary content portions of the edited content and the fingerprints of the registered contents further includes the steps of calculating a similarity or dissimilarity measure between said fingerprints and declaring a match if the similarity is above a pre-determined threshold or if the dissimilarity is below the pre-determined threshold.

Accordingly, the similarity measure indicates how much these fingerprints match. As an example, if they are binary strings then the similarity measure may be computed using the Hamming distance. In particular, the Hamming distance is a measure of dissimilarity and if the Hamming distance is below a threshold the fingerprints are declared to be matching. Similarly, inverse of the Hamming distance may be used as a similarity measure. In this case, the method declares that two fingerprints match if the inverse of the Hamming distance is above a predetermined threshold.

In one embodiment, the similarity threshold is set depending on a reputation measure of the author of the edited content and the log. Accordingly, the idea is to be more lenient or strict depending on whether the author is trusted or not. If for instance the author of the content is trusted, i.e. repeatedly told the truth, that is his identifier/status information in his logs were valid, then the benefit of the doubt is given to the author. This may as an example be done two ways: if the author is claiming that a content portion is from a movie A, the threshold may be decreased such that even if the similarity is low it will be accepted as a match. On the other hand, if the author is claiming that a content portion is ‘user generated’, the threshold may be increased such that even if the similarity with registered content is high it will be accepted as a non-match (and therefore as ‘user generated’).

In one embodiment, the log further specifies use instructions indicating the operations performed on the elementary content portions. Such use instructions may indicate “editing operations” or “operations performed on the elementary contents”, where the elementary content portions are located in the edited content etc.

In one embodiment, the use instructions are implemented as input data in obtaining said fingerprints and said fingerprint comparison. It becomes therefore easier to track out the changes on the elementary content portions contained in the edited content and therefore it becomes easier to match fingerprints. Thus processing power is saved.

In one embodiment, the use instructions contain information about the operations performed on the elementary content portions prior to or after inclusion in the edited content, where the inverse of said operations is performed on the corresponding part of the edited content so as to verify whether the fingerprint of the registered content portions corresponds with the fingerprint of the elementary content portions to which the inverse of said operations is performed. Accordingly, if there is e.g. significant modification of the edited content, the fingerprints from the original content and the edited content may not match. However, a match may still be verified by undoing the editing operations done by the author and then compute the fingerprint.

In one embodiment, the use instructions contain information about the operations performed on the elementary content portions prior to or after inclusion in the edited content, where the operations are performed on the registered contents before corresponding fingerprints are obtained and compared with those that are obtained from the elementary content portions. Accordingly, another way of matching fingerprints is to take the original registered content, apply the editing operations done by the author as e.g. specified in the log and then compute the fingerprints. These fingerprints would match the ones obtained from the received edited content, because now the fingerprinting algorithm does not have to be robust to all those operations.

In one embodiment, the status of parts of the edited content is declared as unknown if its fingerprint matches with none of the fingerprints of the registered contents. In one embodiment, the status of parts of the edited content is declared as author's generated if its fingerprint matches with none of the fingerprints from the registered content and the parts are defined as author's generated in the log submitted by the author.

In one embodiment, said characteristic information for the elementary content portions comprises fingerprints derived from the whole or parts of the content used in the edited content. Accordingly, if the author used “Pirates of the Caribbean” movie, it is possible to indicate in the log the name of the movie. However, in situation where the author is not familiar with the name of the movie, this embodiment allows including a fingerprint of the movie such that it can be used to retrieve the name of the movie later on.

Other advantageous embodiments are set out in the dependent claims.

According to another aspect, the present invention relates to a computer program product for instructing a processing unit to execute the method of the invention when the product is run on a computer.

According to still another aspect, the present invention relates to a server adapted to be coupled to at least one client for identifying elementary content portions from an edited content, to a client for editing content adapted to be coupled to a server and to a system comprising such a client and such a server.

The aspects of the present invention may each be combined with any of the other aspects. These and other aspects of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 shows a flowchart of a method according to the present invention for identifying elementary content portions from an edited content,

FIG. 2 shows a server according to the present invention adapted to be coupled to at least one client via a communication channel,

FIG. 3 shows said client in further details,

FIG. 4 shows another embodiment of a system according to the present invention comprising said server and said client,

FIG. 5 depicts another embodiment of the system in FIG. 4,

FIG. 6 depicts a third embodiment of the system according to the present invention,

FIG. 7 depicts editing operations of two elementary content portions and results in edited content and a corresponding log, and

FIG. 8 depicts a “snapshot” of a commercial video generated by an author.

### DESCRIPTION OF EMBODIMENTS

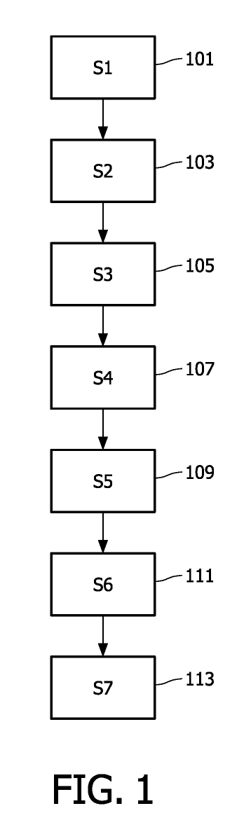

FIG. 1 shows a flowchart of a method according to the present invention for identifying elementary content portions from an edited content. The term content may include audio, e.g. songs, movies or movie clips, audio associated to such movies, digital pictures/videos, and the like.

In step (S1) 101, the edited content is received along with a log, where the log indicates the elementary content portions used in the edited content. As an example of elementary content this document uses the movie “Pirates of the Caribbean”. In step (S2) 103, fingerprints are obtained from the elementary content portions as indicated in the log. This will be discussed in more details later.

In one embodiment, the log further specifies use instructions indicating operations performed on the elementary content portions, but these, but these use instructions may be implemented as input data in obtaining said fingerprints and said fingerprint comparison.

In one embodiment, the use instructions contain information about the operations performed on the elementary content portions prior to or after inclusion in the edited content. Therefore, by obtaining the fingerprints of the registered content that are listed in the log and the fingerprints of the elementary content portions as used in the edited content, one can verify whether these match. There can be a significant modification of the edited content, such that the fingerprints from the registered content and the fingerprints of the elementary content portions as used in the edited content may not match. However, a match may still be verified by undoing the editing operations done by the author and then compute the fingerprint.

In another embodiment, the use instructions contain information about the operations performed on the elementary content portions prior to or after inclusion in the edited content. In this embodiment, the operations are performed on the registered contents before corresponding fingerprints are obtained and compared with those that are obtained from the elementary content portions.

In one embodiment, the log further contains at least some characteristic information about at least one of the elementary content portions used in the edited content, e.g. content portions originating from the client. This may e.g. be home-video, digital pictures, audio tracks/sounds and the like provided from the author of the edited content. The term characteristic information may, according to the present invention, mean metadata or any kinds or types of data associated to the edited content.

In one embodiment, the log further contains one or more of the following information: the ID of the author that edited the content, use instructions indicating about how the elementary content portions were used, the coordinate position of the different elementary content portions used in the edited content, the fingerprints of the elementary content portions as used in the edited content, the time and date of editing the content.

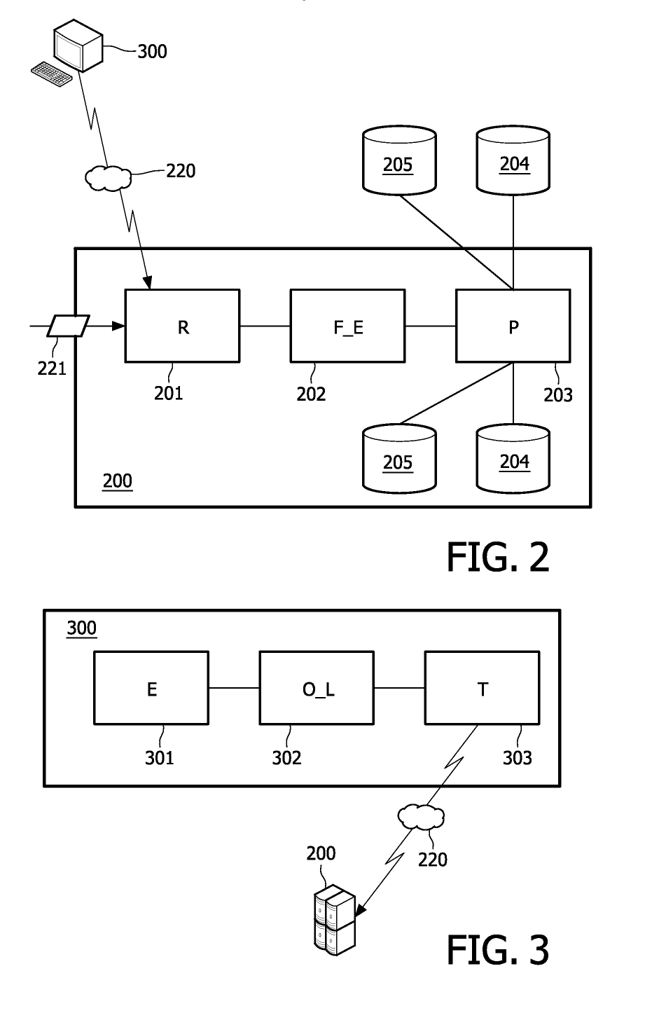

Step (S3) 105 includes determining characteristic information about the elementary content portions by comparing the fingerprints to fingerprints of registered content having associated thereto characteristic information. To this end typically a database is maintained that contains the fingerprints and (often) associated metadata of the registered content. See below with reference to FIG. 2 and more background in the already-mentioned WO 2002/065782-A1.

In one embodiment, such characteristic information is used to obtain rights associated with the elementary content portions and thus to determine rights associated with the edited content. Accordingly, if the edited content consists of elementary content portions A and B and the associated usage rules for these elementary content portion states that each part is available as Creative Commons Attribution Only, then edited content may also be considered as Creative Commons Attribution Only.

In one embodiment, such characteristic information is used to derive a compensation scheme associated with the edited content.

The characteristic information may be identified through identifiers, e.g. a content identifier that identifying the elementary content portions, and/or a source identifier that identifies the source owner of the elementary content portions, and/or a usage or license identifier that identifies the usage or the license rights of the elementary content portions and the like.

In one embodiment, the characteristic information comprises fingerprints derived from the whole or parts of the content used in the edited content. As an example, instead of saying that the edited content is from “Pirates of the Caribbean”, i.e. where it is required that the author of the edited content remembers the title, it is possible to include a fingerprint of the movie in the log. That fingerprint may be used to look up the name and status of the movie.

In one embodiment, the step of comparing said fingerprints in step (S3) is limited to fingerprints of the registered contents having characteristic information matching those as indicated in the log. As an example, a search is performed on the characteristic information (metadata) as defined in the log. As discussed previously, if the “char.info.” say “Pirates of the Caribbean” and the registered content contains three movies with the same title, the fingerprint search/match is done only against those three contents.

Another embodiment of step (S3) includes further the step of calculating a similarity measure between said fingerprints and declaring a match if the similarity is above a pre-determined threshold. As an example, if the similarity threshold is 90% and the result of comparing the fingerprints to the fingerprints of registered matches 95%, a match is declared.

In one embodiment, the method further includes a step (S4) 107 of verifying the validity of the characteristic information contained in the log by checking if said information matches with the characteristic information of the corresponding registered content.

In one embodiment, a reputation measure of the author of the edited content and the log is determined (S5) 109 based on said validity of the characteristic information of said elementary content portions. Thus, if e.g. there is a complete match, the author of the edited content may from e.g. from the scale of 0-1.0 be graded as 1.0, whereas if there is no match the author may be graded as 0.0, i.e. as non honest.

In one embodiment, a similarity threshold is set depending on the reputation measure of the author of the edited content and the log. Thus, it is possible to be more lenient or strict depending on whether the author of the edited content can be trusted or not. For instance, if the author is trusted (i.e. repeatedly told the truth, that is his identifier/status information in his logs were valid) then the benefit of the doubt is given to the author. As an example, an author that has high reputation measure claims that a particular content portion from an edited content is from a movie A. Because of the high reputation measure of the author, the threshold might be decreased such that even if the similarity is low, e.g. 0.3 (from the scale 0-1.0), it will still be considered as a match if the reputation measure of the author is high, e.g. 0.95 (from the scale 0-1.0).

In step (S6) 111, the status of parts of the edited content is declared as unknown if its fingerprint matches with none of the fingerprints of the registered contents. Accordingly, if the edited content contains personal digital images originating from the author of the edited content, there will obviously be no match. Thus, these images are declared as unknown.

In step (S7) 113, the status of parts of the edited content is declared as author generated if their fingerprints match none of the fingerprints from the registered content and the parts are defined as author's generated in the log submitted by the user. Accordingly, instead of declaring them unknown, they are declared as user generated, i.e. from the author of the edited content.

FIG. 2 shows a server 200 according to the present invention adapted to be coupled to at least one client 300 via a communication channel 220 for identifying elementary content portions from an edited content 221 generated by an author located at the client 300 side. The client can be a PC computer, a laptop, a portable device such as PDA or a mobile phone and the like. The communication channel 220 may be a wired or a wireless communication channel such as the Internet.

The server 200 comprises a receiver (R) 201, a fingerprint extractor (F_E) 202 and a processor (P) 203. The receiver (R) 201 is adapted to receive the edited 221 content from the at least one client 300, where the edited content contains one or more elementary content portions and a log indicating the elementary content portions used in the edited content. The fingerprint extractor (F_E) 202 then obtains fingerprints from the elementary content portions as indicated in the log. This may be done as discussed previously under FIG. 1, i.e. the fingerprint extractor obtains the fingerprints from the elementary content portions in the edited content. The processor (P) 203 determines characteristic information about the elementary content portions by comparing the fingerprints to fingerprints of registered content having associated characteristic information. The registered content and the fingerprints of the registered content may be stored at a first and a second local memory 204, 205 located at the server side where the registered content and fingerprints of registered content is stored, or the memories 204, 205 may be located externally at e.g. a central server (not shown).

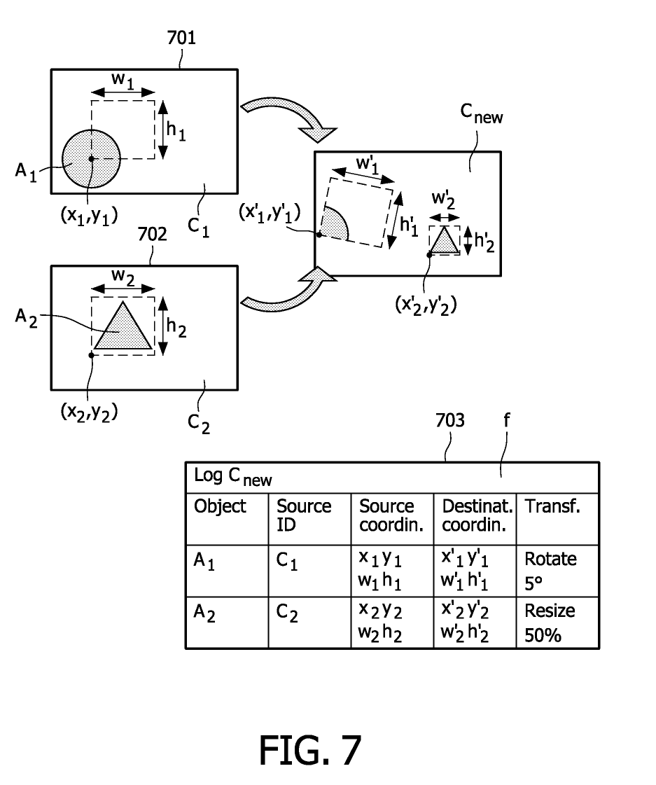

FIG. 3 shows said client 300 in further details, where the client 300 comprises an editor (E) 301, an operation logger (O_L) 302 and a transmitter (T) 303. The editor (E) 301 may be any standard software product, e.g. “photoshop”, “windows movie maker” and the like where e.g. digital pictures, videos, audio etc may be processed and changed in any way by the author operating the client. The operation logger (O_L) 302 is adapted to generate a log indicating the elementary content portions used in the edited content. This may be a manual operation performed by the author or an automatic operation. After editing the content the transmitter (T) 303 transmits it to said server 200. As an example, the edited content is Cnew consisting of two elementary content portions, C1 and C2. In the edited content Cnew, the author rotates C1 by 5° and places it in Cnew at a new location. Additionally, the author resizes C2 by 50% and places this resized section in Cnew at a new location. These operations may be automatically (or manually) registered in the log along with the fingerprints of the edited content. This will be discussed in more details in FIG. 7.

Said server 200 may as an example be a server or a distribution server that manages video sharing sites such as “Youtube”, i.e. a server for consuming and distributing video content, where the video content is uploaded by the public (i.e. authors of the edited content). The content largely originates from two sources: individual authors that record e.g. their holiday video and commercial videos, e.g. an episode of a TV series or a Hollywood movie. The role of this server 200 may accordingly be as an example to remove videos belonging to copyright holders, e.g. movie producers, or share (advertising) revenue with them. This requires the distribution servers of video sharing sites to identify vast amounts of content, e.g. by means of video fingerprinting.

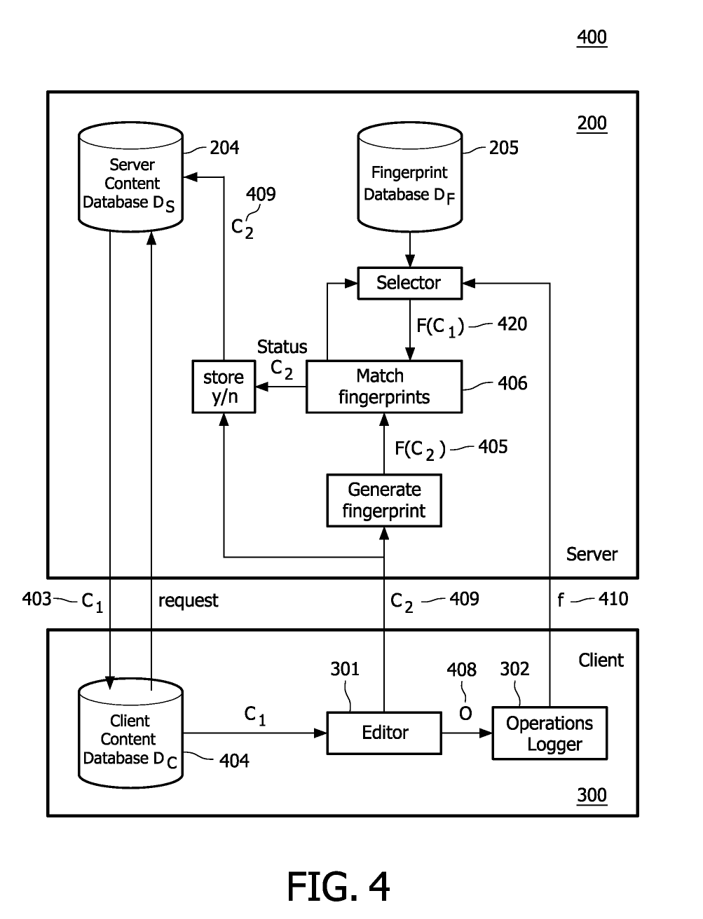

FIG. 4 shows an embodiment of a system 400 according to the present invention comprising said server 200 and said client 300. The server 200 comprises said first memory 204 where the registered content is stored and said second memory 205 where the fingerprint of registered content is stored. The client 300 further comprises a memory 404 where e.g. the client content data is stored.

FIG. 4 depicts the following scenario: An author that operates the client 300 is interested in a particular video C1 403 and requests this video C1 403 at the server 200. The server responds by sending C1 403 to the author. When receiving C1 403 the author makes some editing operations O 408 at the editor 301 resulting in an edited content C2 409. The editing operations O 408 are recorded in the Operations Logger (O_L) 302 resulting in a log, here below referred as file f 410 or log f. The author now desires to share its co-created work with others via the server 200 and uploads both the edited content C2 409 and the log, i.e. file f 410, to the server 200. The server then calculates fingerprint F(C2) 405. Next, the server 200 selects only those fingerprints from the second memory 402 for the content listed in f, i.e. F(C1) 420. The server 200 matches 406 F(C2) 405 to F(C1) 420. If they match the server 200 stores the edited content C2 404 in the first memory 204. Otherwise, the server matches F(C2) to all fingerprints stored at the second memory 205.

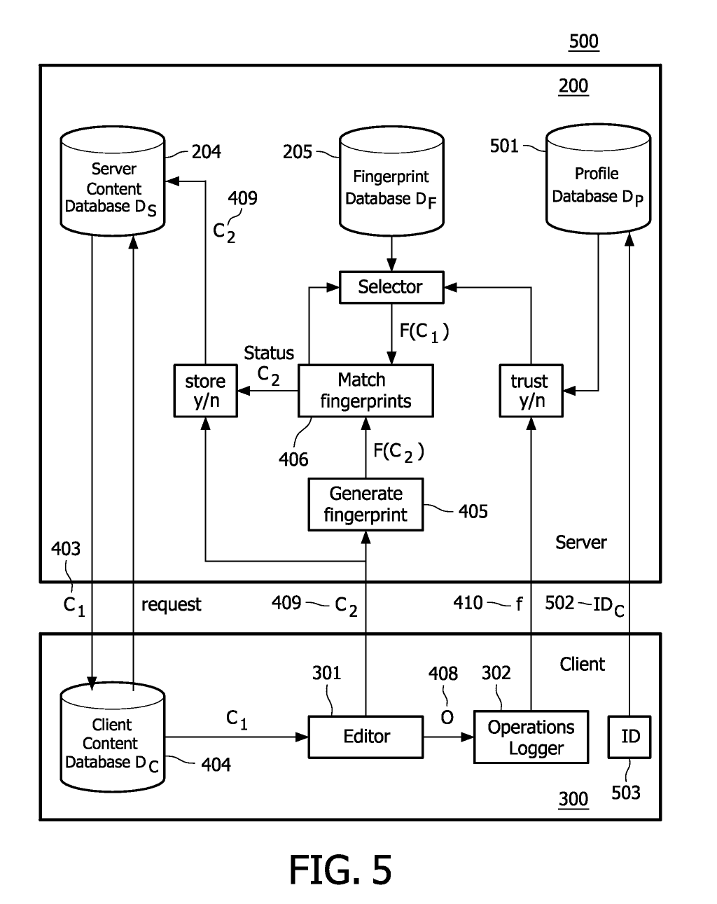

FIG. 5 depicts another embodiment of the system 500 according to the present invention. In this embodiment, the system 500 proposes to gradually start trusting authors that “behave well”, by building a profile for each author through e.g. a reputation measure, where all the profiles are stored in a profile database 501. The reputation measure may e.g. be scaled as between 0-1.0, where “0” is a dishonest author and “1.0” is an honest author. In order to do this, the server 200 keeps profiles or the reputation measures of the authors (or their clients) in the profile database 501. The authors (or his client) have an identity ID_{C} 503, which is associated to the reputation measure of the authors. The log f 410 is trusted depending on the reputation measure of the author of the edited content (i.e. a record of previous interactions between the server and client). The reputation measures may continuously be updated, depending on the outcome of the fingerprint matching. As an example, the reputation measure of the author is increased each time there is a complete match or a match up to a certain threshold (e.g. 90%) between the fingerprints in the log file f 410 and the fingerprints of the registered content stored at said second memory 402.

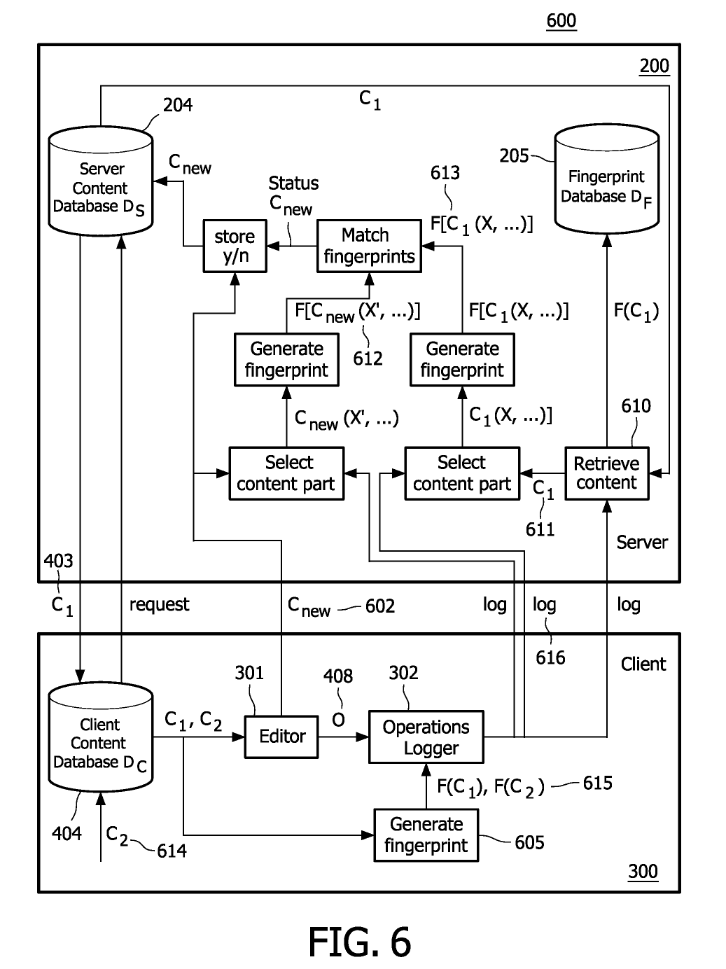

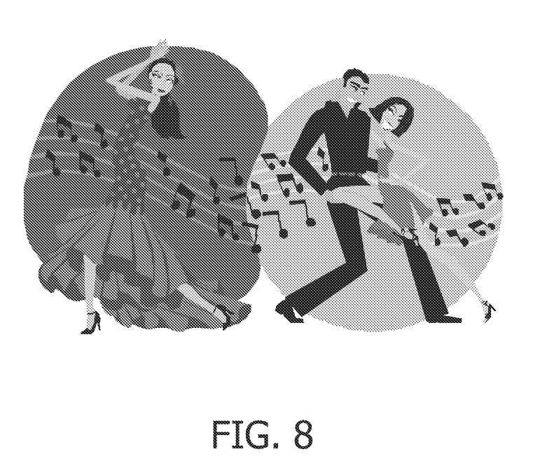

FIG. 6 depicts a third embodiment of a system 600 according to the present invention. Said first and second embodiments in FIGS. 4 and 5 focus on which content an author has reused to generate his new content. Providing this information (i.e. the log) to the server 200 improves fingerprint-based content identification in two ways. Firstly, the more authors are honest (and are trusted by the owner of the server), the less checking is required of the content they upload, which results in saving processing power. In current schemes all authors are regarded as untrustworthy. Secondly, content identification is required only for those elementary content items listed in the log. This will be a significantly smaller number than the total number of e.g. commercial videos on the blacklist of the distribution platform, let alone all videos in the database. By limiting the fingerprint matching to a small number of videos, the number of false positives is reduced. This is important when more commercial content, e.g. videos, are added to the blacklist. It should be noted that when implementing a revenue sharing scheme potentially the entire content database needs to be added to the blacklist: all original works should be identified in all derivative works that are uploaded.

Where the first and second embodiments in FIGS. 4 and 5 focus on which content an author has reused to generate his new content. This third embodiment addresses how this was done. For example, an author superposed a home video of her dancing onto a commercial video of a couple dancing to the same music. This is depicted in FIG. 8. Such editing hampers fingerprint matching between the co-created video and the original commercial movie. Using the log f, a fingerprint is extracted of the right hand side of the video, which is then matched versus the fingerprint of the original commercial movie. Logging editing operations can therefore be used to improve accuracy and reduce false negatives in fingerprint-based content identification.

As depicted here, an author is interested in a particular video and requests this video C1 403 at the server 200. The server 200 responds by sending C1 403 to the author at the client 200 side. The author also obtains a content C2 604 from a source other than the server, e.g. from another server, from the author's own digital camera, from a friend, etc. The author edits C1 403 and C2 614 according to editing operations O 408. The result is an edited content Cnew 602 and subsequently uploaded to the server 200 along with the log f. In this embodiment, the client 300 further comprises a fingerprint generator 605 to generate fingerprints for all the elementary content portions listed in Log f. The fingerprints F(C1) and F(C2) 615 effectively are the source identifiers of C1 403 and C2 614.

FIG. 7 shows one embodiment of how fingerprints from elementary content portions A1 and A2 are registered in the log. The author may as an example select a section of C1 701 located at (x1,y1) with dimensions (w1,h1), rotate it by 5° and place this section in C3, at location (x′1,y′1) with dimensions (w′1,h′1). The author may also select a section of C2 702 located at (x2,y2) with dimensions (w2,h2), resize it by 50% and place this section in C3, at location (x′2,y′2) with dimensions (w′2,h′2). These operations O are captured in log file “f” 703, where “f” may be a table that shows the elementary content portions A1 and A2 or any other content portions used (e.g. if A2 comes from a personal video made by the author), where for these objects the source ID is given, the source coordination, destination coordination and the transformation.

Continuing now with FIG. 6, the author of the edited content 602 desires to share its co-created work, i.e. the edited content, with others via the server 200 and uploads Cnew 602 and the log f 616 to the server 200. The server 200 retrieves the content 610 that was used by matching F(C1) and F(C2) 615 against the fingerprint database stored at the second memory 402. The Content Retrieval functions 610 returns content C1 611 from DS. Next, the server 200 parses log f. It selects section (x′1,y′1) with dimensions (w′1,h′1) from Cnew 602 and calculates fingerprint F[Cnew(x′1,y′1,w′1,h′1)] 612. In parallel, the server 200 selects section (x1,y1) with dimensions (w1,h1) from C1 and calculates fingerprint F[C1(x1,y1,w1,h1)] 613. Next, the server 200 matches these two fingerprints. If they match, a part of Cnew 602 has been accounted for. In this way, the content identification is performed for all parts of Cnew 602. Having identified all parts, the status of these parts is determined (e.g. status as ‘blacklisted’, by retrieving the license associated to the content etc.). Depending on the status information, it is decided whether to publish Cnew or not.

Certain specific details of the disclosed embodiment are set forth for purposes of explanation rather than limitation, so as to provide a clear and thorough understanding of the present invention. However, it should be understood by those skilled in this art, that the present invention might be practiced in other embodiments that do not conform exactly to the details set forth herein, without departing significantly from the spirit and scope of this disclosure. Further, in this context, and for the purposes of brevity and clarity, detailed descriptions of well-known apparatuses, circuits and methodologies have been omitted so as to avoid unnecessary detail and possible confusion.

Reference signs are included in the claims; however the inclusion of the reference signs is only for clarity reasons and should not be construed as limiting the scope of the claims.

1. A method for identifying elementary content portions from an edited content, the method comprising:
receiving said edited content and a log indicating one or more elementary content portions used in the edited content,
obtaining fingerprints from the one or more elementary content portions as indicated in the log, and
determining characteristic information about said elementary content portions by comparing said fingerprints to fingerprints of registered content having associated characteristic information.

2. The method according to claim 1 wherein said characteristic information is used to obtain rights associated with the elementary content portions and thus to determine rights associated with the edited content.

3. The method according to claim 1 wherein said characteristic information is used to derive a compensation scheme associated with the edited content.

4. The method according to claim 1, wherein the log further contains at least some characteristic information about at least one of the elementary content portions used in the edited content.

5. The method according to claim 4, wherein said step of comparing said fingerprints is limited to fingerprints of the registered contents having characteristic information matching those as indicated in the log.

6. The method according to claim 4, wherein the characteristic information includes a usage license of the elementary content portions, the method further including the step of verifying the validity of the usage license.

7. The method according to claim 1, further comprising verifying the validity of the characteristic information contained in the log by checking if said information matches with the characteristic information of the corresponding registered content.

8. The method according to claim 8, wherein a reputation measure of the author of the edited content and the log is determined based on said validity of the characteristic information of said elementary content portions.

9. The method according to claim 1, wherein the step of comparing the fingerprints obtained from the elementary content portions of the edited content and the fingerprints of the registered contents further includes the steps of calculating a similarity or dissimilarity measure between said fingerprints and declaring a match if the similarity is above a pre-determined threshold or if the dissimilarity is below the pre-determined threshold.

10. The method according to claim 9, wherein the similarity threshold is set depending on a reputation measure of the author of the edited content and the log.

11. The method according to claim 1, wherein the log further specifies use instructions indicating the operations performed on the elementary content portions.

12. The method according to claim 11, wherein the use instructions are implemented as input data in obtaining said fingerprints and said fingerprint comparison.

13. The method according to claim 12, wherein the use instructions contain information about the operations performed on the elementary content portions prior to or after inclusion in the edited content, where the inverse of said operations is performed on the corresponding part of the edited content so as to verify whether the fingerprint of the registered content portions corresponds with the fingerprint of the elementary content portions to which the inverse of said operations is performed.

14. The method according to claim 12, wherein the use instructions contain information about the operations performed on the elementary content portions prior to or after inclusion in the edited content, where the operations are performed on the registered contents before corresponding fingerprints are obtained and compared with those that are obtained from the elementary content portions.

15. The method according to claim 1, wherein the status of parts of the edited content is declared as unknown if its fingerprint matches with none of the fingerprints of the registered contents.

16. The method according to claim 4, wherein the status of parts of the edited content is declared as author's generated if its fingerprint matches with none of the fingerprints from the registered content and the parts are defined as author's generated in the log submitted by the author.

17. The method according to claim 1, where characteristic information for the elementary content portions comprises fingerprints derived from the whole or parts of the content used in the edited content.

18. The method according to claim 1, wherein the log includes at least one of the following information:
an identifier identifying the elementary content portions used in the edited content,
the ID of the author of the edited content,
use instructions indicating how the elementary content portions were used,
the coordinate position of the different elementary content portions used in the edited content,
the fingerprints of the elementary content portions as used in the edited content, and
the time and date of editing the content.

19. The method according to claim 1, wherein said edited content is obtained from a client side where said log associated with the edited content is generated, the generation of the log file comprising:
obtaining characteristic information for at least one of the elementary contents used in the edited content and registering the characteristic information in the log, and
indicating the elementary contents used in the edited content.

20. A computer program product for instructing a processing unit to execute the method step of claim 1 when the product is run on a computer.

21. A server adapted to be coupled to at least one client for identifying elementary content portions from an edited content, the server comprising:
a receiver for receiving said edited content and a log indicating one or more elementary content portions used in the edited content,
a fingerprint extractor for obtaining fingerprints from the elementary content portions as indicated in the log, and
a processor for determining characteristic information about said elementary content portions by comparing said fingerprints to fingerprints of registered content having associated characteristic information.

22. A client for editing content adapted to be coupled to a server, comprising:
an editor for receiving editing operations from an author, the editing operations resulting in an edited content containing at least two elementary content portions,
an operation logger for generating a log indicating the elementary content portions used in the edited content, and
a transmitter for transmitting the edited content and the log to the server.

23. A system for identifying elementary content portions from an edited content, the system comprising a client for editing content adapted to be coupled to a server, comprising:
an editor for receiving editing operations from an author, the editing operations resulting in an edited content containing at least two elementary content portions,
an operation logger for generating a log indicating the elementary content portions used in the edited content, and
a transmitter for transmitting the edited content and the log to the server and a server as claimed in claim 21.
